(19) United States
(12) Patent Application Publication
(10) Pub. No.: US 2021/0324206 A1
(43) Pub. Date: Oct. 21, 2021

(54) ANTIFOULING COATING

(71) Applicant: SHENZHEN YUANJINGANG NEW MATERIALS CO., LTD., Shenzhen (CN)

(72) Inventors: Jan DIETRICH, Paderborn (DE); Wolfgang BREMSER, Paderborn (DE); Wu-Song LI, Shandong (CN); Christian-Cedric KLUTE, Bad Meinberg (DE)

(73) Assignee: SHENZHEN YUANJINGANG NEW MATERIALS CO., LTD., Shenzhen (CN)

(21) Appl. No.: 17/251,432

(22) PCT Filed: Jun. 7, 2019
(86) PCT No.: PCT/EP2019/064994

§ 371 Date: Dec. 11, 2020

(30) Foreign Application Priority Data
Jun. 12, 2018 (DE) 10 2018 114 018.5

(51) Int. Cl. C09D 5/16; C09D 183/08

(52) U.S. Cl. CPC C09D 5/1675; C09D 183/08

(57) ABSTRACT

The present invention concerns a composition for a surface coating (10), in particular for aquatic applications, characterized in that the composition (12) has a polymer structure which is composed of at least three units, a first unit comprising a dendrimer structure based on a polyamidoamine, a second unit (14) comprising an epoxy resin, and a third unit (16) comprising an amine-reactive polysiloxane, the polymer structure being arranged such that the first unit is formed as a central unit to which the second unit (14) and the third unit (16) are each covalently bonded

The present invention relates to an antifouling coating. The present invention also relates to a process for producing such an antifouling coating.

Biofouling refers to the colonisation of aquatic habitats on exposed surfaces by microorganisms (microfoulers) and larger organisms (macrofoulers). In order for the latter to settle permanently on a surface, the surface must first be gradually covered with the so-called conditioning film consisting of organic material and successively colonised first by bacterial and fungal organisms and finally by macroscopic organisms.

Biofouling can increase the fuel consumption of ships by up to 40%, resulting in estimated annual damage of €200 billion. It is also estimated that the additional emissions of NOx, SOx, CO₂ and other toxic pollutants caused by biofouling can kill up to 60,000 people a year. This is described for example in Selim et al: Recent progress in marine foul-release polymeric nanocomposite coatings, Progress in Material Science 2017 (1-32).

One type of existing coatings to prevent biofouling releases biocidal substances. The import, sale and use of biocide-containing marine paints in the EU is subject to strict regulation or prohibition (biocidal products regulation BPR, product type PT 21). Further bans are currently being discussed.

Biocides are a danger to humans because of their toxicity during application. This also applies to the only category of copper biocides currently still permitted. Copper is associated in higher doses with Alzheimer's disease and can lead to cirrhosis of the liver. The environment is contaminated by the heavy metals used over long periods on land and at sea. The toxins used lead to mutations and death in marine organisms, as described for example in Squitti et al., 2018, doi.org/10.1016/j.jtemb.2017.11.005

Another possibility is the coating with low surface energy, which should reduce the adhesion of bio-organisms. Special coatings of this type are hydrogel release coatings, which further reduce adhesion by slowly diffusing a hydrogel from the coating over a period of time.

Another way to combat biofouling is to clean the paint on the ship. This is usually done by high-pressure water jet cleaning or by ultrasound.

CN 104892946 A describes the production of polysiloxane-modified poly(amidoamine) In the production process, the first generation poly(amidoamine) is reacted with a single functionalised epoxypolysiloxane.

WO 2004/046452 A2 describes formulations containing at least one nitrogen-free polysiloxane compound, at least one polyamino- and/or polyammonium-polysiloxane compound and/or at least one amino and/or ammonium-polysiloxane compound, and optionally a silicone-free cationic surfactant, a coacervate phase former and carrier substances. Further described are also a process for the preparation of these formulations and their use in the treatment of natural and synthetic fibrous materials.

WO 2014/164202 A1 describes epoxy-polysiloxane-based coating and floor covering compositions that are intended to show improved flexibility and excellent weathering and corrosion resistance after curing. The epoxy-polysiloxane polymer coating composition can be prepared by combining a polysiloxane, an epoxy resin material and a curing system including a mixture of compounds selected from a dialkoxy functional aminosilane, a trialkoxy functional aminosilane and an amino functional polysiloxane resin. The composition has an average alkoxy functionality value of 2.0 to 2.8.

WO 03/093352 A1 describes an epoxy-polysiloxane composition obtained using a defined polysiloxane, an epoxy resin and an aminopolysiloxane hardener. Such a composition can be used in reacted or cured form for example as a coating, for example as a protective layer. Preferred properties shall be for example improved hardness, gloss retention and weather resistance.

US 2002/0156187 A1 describes epoxy-functionalised organopolysiloxane resins which serve as coatings for industrial equipment or surface applications. The organosiloxane resins are reacted with curing agents. Among the examples mentioned, one includes polyamidoamines.

Poly(amidoamine-organosilicone) (PAMAMOS) multi-arm star polymers, Petar R. Dvornic et al, Silicon Chemistry, May 2002, Volume 1, Issue 3, pp 177-193 https://link.springer.com/article/10.1023/A:1021203611376, as well as U.S. Pat. No. 6,350,384 B1, also describe poly(amidoamine-organosilicone) (PAMAMOS) polymers. Such polymers can be produced, for example, by binding polydimethylsiloxane (PDMS) to polyamidoamine (PAMAM).

U.S. Pat. No. 6,812,298 B2 describes hyperbranched polymers, such as polyamidoamides, which can be produced from multifunctional carboxylic acids and multifunctional amines.

U.S. Pat. No. 6,350,384 B1 describes polymers with a hydrophilic dendritic core and hydrophobic silicone-containing arms.

In WO 2008/148568 A2 a nanoparticle (nanotransporter) is disclosed, which comprises a core-shell structure with a single or double shell system for non-covalent introduction and/or transport of monovalent metal ions, preferably silver ions. The nanoparticle has a dendritic core and at least one shell. The nanoparticles according to the invention, which contain incorporated silver ions, make it possible to achieve an extremely high microbicidal effect even at very low concentrations, so that these nanoparticles can be advantageously used as microbicides or bactericides in various fields.

N. Misdan et al., Recent advances in the development of (bio)fouling resistant thin film composite membranes for desalination, Desalination 380 (2016)105-111, describes a treatment of desalination membranes to reduce biofouling. Dendrimers can be bonded directly to a polyamide surface of the membrane. Nanoparticles, such as silver particles, can be used to reduce biofouling.

In Silicon containing polymers, Springerbooks, Petar R. Dvornic describes dendrimers in general, which are made of an epoxy terminated polydimethylsiloxane and a polyamidoamine dendrimer.

EP 2818497 A2 describes a composite comprising a substrate; a binder layer disposed on a surface of the substrate; and a nano-filler layer comprising nanographene and being disposed on a surface of the binder layer opposite the substrate. In addition, a nanocoating layer for coating a substrate comprises a plurality of alternating layers of the binder layer and the nanofiller layer. For example, the binder layer may comprise polyamidoamine (PAMAM) as a dendrimer.

U.S. Pat. No. 7,923,106 B2 describes a reactive coated substrate, said substrate comprising an interface surface to which a reactive coating is adhered, said reactive coating comprising (a) at least one silicone-based substantially hydrophobic polymer and (b) at least one substantially hydrophilic polymer, wherein said reactive coating substrate is in a first state; and a method of coating the same. The coated substrate may comprise particles of, for example, polyamidoamine and the coating may comprise, for example, polydimethylsiloxane.

WO 2014/121570 A1 describes that the hardness of epoxy resins can be influenced by appropriate additions. Examples of such additives include dendrimer-functionalised particles of silicon dioxide or titanium dioxide.

U.S. Pat. No. 5,902,863 describes dendrimers that contain, for example, polyamidoamines that are functionalised with organosilicon compounds. Such compounds are used for example in membranes or coatings for electronic components.

U.S. Pat. No. 5,739,218 also describes dendrimers that contain, for example, polyamidoamines that are functionalised with organosilicon compounds. In this document applications are described in particular as water and oil repellent coatings.

U.S. Pat. No. 6,077,500 describes a further reaction of the dendrimers described in U.S. Pat. No. 5,379,218 as before, for example by hydrosilylation, in order to be able to adjust the properties of the dendrimers.

Masayoshi et al: “Curing of Epoxy Resin by Hyperbranched Poly(amidoamine)-grafted Silica Nanoparticles” in Polymer Journal, Vol. 40, No. 7, page 607-613, 2008, describes nanoparticles as fillers and pigments for polymer materials. Such nanoparticles include silica functionalised with dendrimers. The dendrimer can be a polyamidoamine and can be reacted with boron trifluoride. Such nanoparticles should be incorporated into an epoxy resin network by covalent bonds.

EP 3 170 872 A1 describes antifouling coatings. Such coatings comprise an epoxy resin and a hardener. The hardener comprises in particular hydrophobic nanoparticles of a dendrimer functionalised with a lipophilic group. The latter are called ammonium groups.

The dissertation of Qiang Wie, “Mussel-Inspired Polyglycerols as Universal Bioinert and Multifunctional Coatings”, Free University Berlin, describes hyperbranched polyglycerols as antifouling agents.

However, the solutions described above still offer potential for improvement, especially with regard to an effective and biologically harmless antifouling effect of surface coatings for aquatic applications. A major disadvantage of existing fouling release coatings based on silicone and elastomer binders is also their low mechanical stability.

It is therefore the object of the present invention to provide a measure by which an effective and biologically harmless antifouling effect of surface coatings for aquatic applications can be achieved in a simple manner and which is characterised by its high mechanical stability.

According to the invention, the object is solved by a composition for a surface coating with the features of claim 1. The object is further solved by a surface coating with the features of claim 7. The object is further solved by a process for producing a composition with the features of 13. The object is further solved by a process for coating a substrate with the features of 15. Preferred embodiments of the invention are disclosed in the dependent claims, the description and the figure, whereby further features described or shown in the dependent claims or in the description or the figure or the example, individually or in any combination, may constitute an object of the invention unless the context clearly indicates otherwise.

It is proposed a composition for a surface coating, in particular for aquatic applications, wherein the composition has a polymer structure which is composed of at least three units, a first unit comprising a dendrimer structure based on a polyamidoamine, a second unit comprising an epoxy resin, and a third unit comprising an amine-reactive polysiloxane, the polymer structure being composed such that the first unit is formed as a central unit to which the second unit and the third unit are each covalently bonded.

A surface coating of such a composition allows very good antifouling properties for aquatic applications and can also have a high mechanical stability.

The composition described here for a surface coating is especially intended for use in a surface coating for aquatic applications. Aquatic applications are to be understood in particular as those applications in which the surface coating comes into contact with water temporarily, largely permanently or exclusively, for example covered with water. Examples of applications include coatings for any component which, in its intended use, is below the water surface and thus positioned in the water, such as static components, e.g. buildings or pillars which are below the water surface, or in particular hulls of ships. In concrete terms, the composition described here can be used for a surface coating, such as an antifouling coating for boat hulls.

It may also be preferred that the component is a water-carrying volume, such as a pipe or tube for carrying water, or that the surface coating is an internal coating of a water-carrying volume, such as a pipe for carrying water. This can also be of significant advantage, as the free pipe diameter can be maintained in this way, thus preventing or at least reducing costly maintenance work. Non-restrictive examples include water supply lines, such as raw water supply lines, cooling or waste water lines or even internal heat exchanger surfaces.

Alternatively, this composition, or the surface coating that can be achieved through it, can also be used for a coating that serves to prevent ice build-up.

Fouling, or biofouling in particular, is the colonisation of aquatic habitats on exposed surfaces by micro-organisms (microfoulers) and larger organisms (macrofoulers). In order for the latter to settle permanently on a surface, the surface must first be gradually covered with the so-called conditioning film consisting of organic material and successively colonised first by bacterial and fungal organisms and finally by macroscopic living organisms. It is thus evident that fouling can be prevented or at least significantly reduced by preventing the adhesion of corresponding organisms. This is allowed by a composition according to the present invention.

With regard to composition, it is provided that it comprises a polymer structure or a copolymer structure, respectively, composed of at least three units. For example, the composition may consist of this polymer structure. Thus, three units can be provided or more than three units can be provided without leaving the scope of the invention.

The first unit, or monomer structure, respectively of the polymer structure comprises a dendrimer structure based on a polyamidoamine. For example, the first unit consists of a dendrimer structure based on a polyamidoamine. A polyamidoamine can be a dendritic structure that is built up of amide groups and is amine functionalised.

A representative of polyamidoamides is for example formed according to structure 1, as shown below.

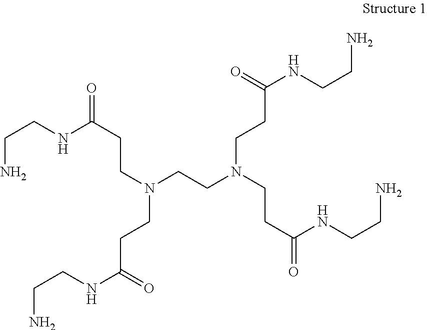 [SMILES: NCCNC(=O)CCN(CCC(=O)NCCN)CCN(CCC(=O)NCCN)CCC(=O)NCCN]

This structure 1 shows a so-called zero-generation polyamidoamine.

It is also provided that a second unit or monomer structure, respectively, includes an epoxy resin. In principle, the epoxy resin used can be chosen freely. For example, the epoxy resin can be one based on bisphenol, such as bisphenol A, and epichlorohydrin as reaction educts, but this is not limited to this. This can provide a particularly good hardness and also a high stability even under aquatic conditions.

Basically, the epoxy resin can thus have the following structure in a manner known per se, as shown purely schematically in structure 2 as follows

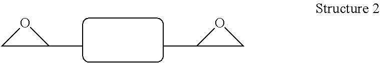

It has been shown that the epoxy resin has a base structure which has two epoxy groups. Based on the epoxy groups present, the epoxy resin can easily react with the amine groups of the dendrimer structure described above and thus covalently bond to the dendrimer structure to produce the polymer as described for the composition.

Furthermore, the amine-reactive polysiloxane used as the third unit or monomer structure, respectively, can also be chosen freely. However, attention should be paid to functionality to allow the polysiloxane to react with the amine groups of the dendrimer structure described above to produce the polymer as described for the composition. In other words, the polysiloxane is amine-reactive.

For example, the polysiloxane can be an epoxy-functionalised polysiloxane. In this respect, it may be preferred that the epoxy-functionalised polysiloxane is a polydimethylsiloxane.

As a result, the polysiloxane has a design corresponding to structure 3, as shown below.

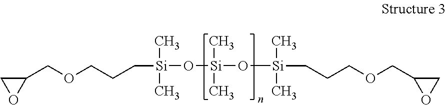

In this respect, structure 3 provides that the variable n is an integer and is in a range from ≥1 to ≤50, for example from ≥1 to ≤15.

Based on the three units or structures mentioned above, the composition has a polymer structure which is constructed in such a way that the first unit is formed as a central unit to which the second unit and the third unit are each covalently bonded. In other words, the dendritic structure forms a central unit to which both the polysiloxane and the epoxy resin are covalently bonded using the reactive groups, such as the epoxy groups.

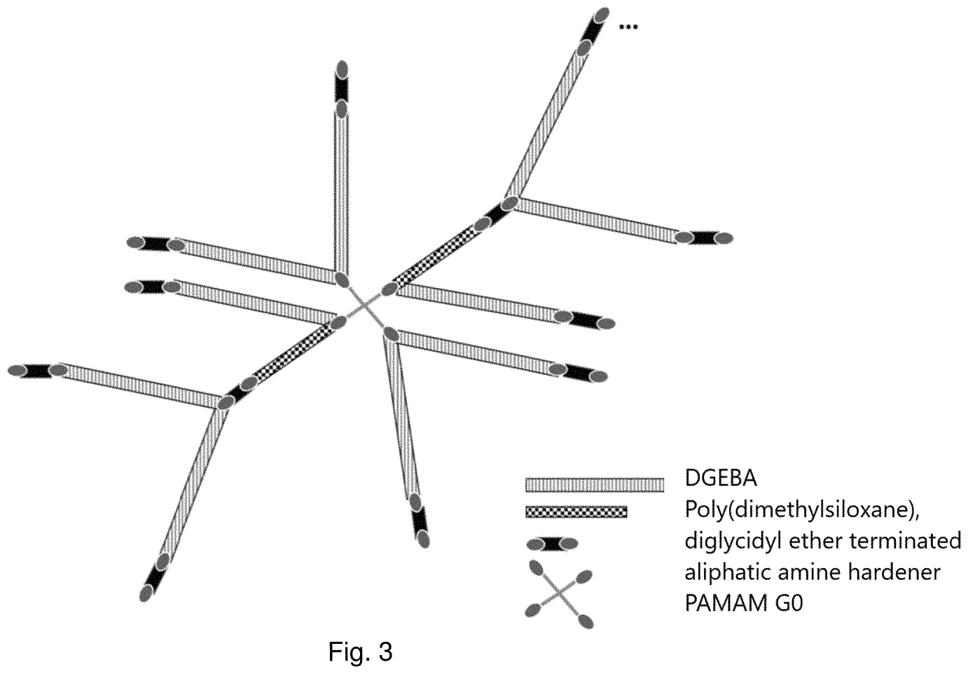

Such a polymer structure as the main component of the composition is thus preferentially constructed, as shown in FIG. 3.

In this structure, the central unit is thus the zero-generation PAMAM shown above, to which a diglycidyl ether-terminated polydimethylsiloxane is bonded, and DGEBA resin (bisphenol A diglycidyl ether) as epoxy resin. It is also shown that the resin is cured by a hardener, as described in more detail below.

To form the polymer structure using the dendrimer structure, the epoxy resin and the polysiloxane, polymerisation or covalent bonding of the three units can be carried out in a manner known per se, the epoxy groups of the epoxy resin and the functional amine-reactive groups of the polysiloxane reacting with corresponding amine groups of the dendrimer structure. The polymerisation conditions can be selected in a manner known per se to allow the above units to be bonded.

It can be particularly advantageous here if the polysiloxane also has a functionality that does not react with epoxy groups, thus preventing a reaction between epoxy resin and polysiloxane. Accordingly, it may be particularly preferable, in itself understandable, that the polysiloxane or, in one form or another, the polydimethylsiloxane is epoxy-functionalised, e.g. glycidyl ether terminated as described above, thus carrying epoxy groups, in order to prevent copolymerisation with the epoxy resin and to enable the epoxy resin and the polysiloxane to react with the dendrimer structure.

Such a composition or a surface coating that can be produced from it can have significant advantages over coatings known from the state of the art, such as anti-fouling coatings.

A surface coating formed from the composition as described here can have effective antifouling properties. These can be achieved in particular by or are based on blockopoylmermi cells, which are formed from the polysiloxane.

The effective antifouling action can be achieved in particular by the presence of polysiloxane domains. The anti-fouling effect of these polymer systems is not only due to the hydrophobicity and surface tension that can be achieved by the polysiloxane domains, but also, without being limited to theory, to the quasi-liquid behaviour of these domains. Due to a non-rigid but dynamic behaviour of the polysiloxane domains, a quasi-liquid dynamic surface can be available, which does not provide an adhesion basis for microorganisms. Thus, it can be prevented that corresponding organisms settle or adhere to the surface, which can take away the basis of fouling.

It has been shown that, in particular but not limited to this, using polydimethylsiloxane (PDMS) as polysiloxane and thus polydimethylsiloxane to form the polysiloxane blocks or polysiloxane domains, the latter can effectively prevent fouling.

After creating the surface coating, such as after applying the coating to a substrate, the hydrophobic surfaces of the polysiloxane domains are surrounded by a hard polymer matrix, the epoxy resin components. Thus, by providing the epoxy resin, a very stable structure can be created which can also withstand high mechanical forces. In particular, it is possible to improve the mechanical properties and resistance to external forces, which can occur during cleaning processes or other loads, without, however, impairing the antifouling properties. This makes it possible that even if fouling should occur or it becomes necessary to treat the surface mechanically, this can be done without damaging or destroying the surface coating. For example, it is possible to clean the surface with ultrasound or a high pressure jet without any problems. This was often not possible or only possible to a limited extent with state-of-the-art solutions. By using a composition described here, it is therefore possible to clean the surfaces of boat hulls, for example, even at the biofilm stage, so that no macro foulers can settle.

The advantage of a dendrimer structure as a central building block can also be seen in the fact that it can order the overall structure or create the structure and thus provide the positive properties of the composition. In detail, the fact that the dendrimer structure is intended as the central structure to which the polysiloxane and the epoxy resin are bound means that the spatial structure of the polymer structure can be adjusted. A dendrimer structure is particularly preferred because, based on the mass or the proportion of the dendrimer structure as such, a large number of connection points are provided at which epoxy resin or polysiloxane can be bonded. This results in a high proportion of active components, namely polysiloxane for a good antifouling effect and the epoxy resin for high mechanical stability.

Dendrimers are characterised by their globular structure and the absence of tangles and can therefore be used particularly well as additives in polymer systems. The solubility of dendrimers is also generally higher than referred to linear polymers. These properties are advantageous for the fast and homogeneous adjustment of phase-separated systems.

Thus, the composition described here can result in a coating with a surface that is formed by phase separation of substances that are not soluble or miscible in each other, namely the epoxy resin and the polysiloxane. This results in spherical domains of the polysiloxane in particular, which are surrounded by the epoxy matrix, which can lead to the good antifouling properties and at the same time to the high mechanical stability.

The composition described here may also be advantageous, as it is preferably free of biocides and therefore there is no risk of damage to the environment. This also offers the further advantage that a surface coating formed from the composition does not have a half-life caused by diffusing substances, as can occur with coatings containing biocides but also with coatings containing hydrogels.

An advantage of the effective antifouling or clean surfaces made possible by the present invention can also be seen in the fact that aquatic static components can exhibit improved long-term stability. In the case of ship paints, for example, improved antifouling properties can be a major advantage, as biofouling can increase the fuel consumption of ships by up to 40%, resulting in estimated annual damage of €200 billion. Furthermore, the additional emissions of NOx, SOx, CO₂ and other toxic substances caused by biofouling are extremely harmful to people and the climate. These effects can therefore be effectively counteracted by the composition described here or by a surface coating that has such a composition.

It may also be preferred that the component is a water-carrying volume, such as a pipe or tube for carrying water, or that the surface coating is an internal coating of a water-carrying volume, such as a pipe for carrying water. This can also be of significant advantage, as the free pipe diameter can be maintained in this way, thus preventing or at least reducing costly maintenance work. Non-restrictive examples include water supply lines, such as raw water supply lines, cooling or waste water lines or even internal heat exchanger surfaces.

It may be preferably provided, that the polyamidoamine comprises one of a zero- or first-generation. It has been shown in a surprising way that a composition or a surface coating formed from it can provide particularly effective antifouling properties with high stability, especially in this design. Without being restricted to this theory, this may be due to the fact that the basic structure, which essentially serves to anchor the epoxy resin and the polysiloxane, has a comparatively low proportion, so that in other words the proportion of epoxy responsible for high stability and the proportion of polysiloxane responsible for good antifouling effect may be particularly high. This means that the positive properties of the polysiloxane and the epoxy resin can essentially be retained. Anchoring is increased by the large number of free functional groups of the dendrimer. Apart from the anchoring of the PDMS in the coating, the dendrimer increases the network density, which leads to higher hardness and increased chemical resistance.

It may also be preferred that the polysiloxane is a di-epoxy functionalised polydimethylsiloxane. As indicated above, this design, by providing the epoxy groups, has the advantage that, on the one hand, a problem-free and effective reaction of the polysiloxane with the amine groups of the dendrimer structure is made possible and, on the other hand, no reaction with the epoxy resin is to be feared. Accordingly, the desired structure or composition can be produced under easily adjustable conditions and in a specially defined way, for example by adjusting the quantity of the respective components in the reaction. Furthermore, it has been found that, especially in this design, effective integration into the matrix is possible, for example, by reacting both epoxy groups with a dendrimer structure or also by reacting epoxy groups that do not react with the dendrimer with a hardener that can be added if necessary. This allows a particularly strong anchoring of the polysiloxane in the matrix, which can lead to a particularly high hardness of the coating and thus to a high mechanical resistance.

In other words, when a di-epoxy functional polysiloxane is used, the dual functionality of the hydrophilic groups used can result in a high network density and thus in great hardness and scratch resistance of the surface. In addition, a particularly good surface structure can be produced in this way.

However, it may also be advantageous, depending on the application, that the polysiloxane comprises a mono-epoxy functionalised polydimethylsiloxane. This structure can also at least partially fulfil the advantages described above, but the polysiloxane can react in a defined manner only with the dendrimer structure. This allows the quasi-liquid behaviour of the polysiloxane to be further developed, which may positively acto to the antifouling effect in some applications.

It may also be preferred that the epoxy resin is cured by a hardener. This can be realised in the manner known per se to the person skilled in the art by using a hardener system known per se, for example based on or consisting of an amine hardener. Accordingly, it can be an advantage in a way that is understandable to the person skilled in the art that not all epoxy groups of the epoxy resin have reacted with the dendritic structure before, but that there are still enough epoxy groups available for a desired hardening. Furthermore, the hardener can be added in a reaction with the dendrimer, so that a parallel reaction of the epoxy resin with the hardener and the dendrimer is possible. This can be easily realised in a way that is directly realisable for the person skilled in the art by taking into account the molar number of the respective functional groups when producing the block copolymer and by having more epoxy groups of the epoxy resin than corresponding functional groups of the dendrimer structure. Especially in this design, it is possible that the composition or a surface coating formed from it can have a particularly high hardness or stability.

It may also be preferred that the dendrimer structure is present in the composition in a proportion from ≥0.3 wt % to ≤0.8 wt %. It has been shown in a surprising way that a composition or a surface coating formed from it can provide particularly effective antifouling properties with high stability, especially in this design. Without being restricted to this theory, this may be due to the fact that the base structure, which essentially serves to anchor the epoxy resin and the polysiloxane, has a comparatively low proportion, so that in other words the proportion of epoxy responsible for high stability and the proportion of polysiloxane responsible for a good antifouling effect may be particularly high.

From the above it is therefore clear that, in a surprising way, especially the composition described above can provide the desired property matrix of high mechanical stability and effective antifouling properties. The proportion of cross-linked epoxy in particular can provide high mechanical stability, the polysiloxane can enable an effective antifouling effect and the dendrimer structure can define the epoxy resin and the polysiloxane and thus the structure of the polymer, so that the desired advantages can be made possible in a particularly effective way.

In addition, a surface coating with the composition described here can be present or can be applied in the form of a lacquer, which can enable simple and unproblematic application using familiar methods. This means that processes for coating of components or, for example, ships do not need to be adapted, but the processes known per se, for example for painting boat hulls, can continue to be used without problems. This allows a particularly simple implementation of the surface coating described here into existing manufacturing or maintenance processes.

With regard to other advantages and technical characteristics of the composition, explicit reference is hereby made to the description of the surface coating, the process for producing a composition, the process for coating a substrate, and the figures, the example and the description of the figures, and vice versa.

Further described is a surface coating for a substrate, wherein the surface coating is applied to the substrate and thus at least partially covers the substrate. It is provided that the surface coating has a composition as described in detail above.

A surface coating defined here can have significant advantages over state-of-the-art solutions. Because the surface coating, by having a composition as described above, can have a matrix of properties that combines an effective antifouling effect with high mechanical stability and easy application.

Accordingly, the surface coating, although in no way limited to this, may be particularly preferred for aquatic applications. Thus, it may be particularly preferred if the component is a component for aquatic applications, in particular if the component is a hull of a watercraft, such as a ship's hull, or an aquatic static element, such as part of a building, columns or other immovable components or elements, such as water-carrying volumes.

In addition to the composition described above, the surface coating may also contain other additives, such as solvents, e.g. butyl acetate, or pigments for the colouring of the coating.

In particular, it can be advantageous that the units comprising polysiloxane form domains which at least partially have a size in a range from ≥0.05 μm to ≤1 μm, preferably from ≥0.9 μm to ≤0.4 μm. In particular, it may be provided that the units comprising polysiloxane form domains which, in a proportion of ≥50%, preferably ≥80%, about ≥95%, based on the number of domains, preferably all the domains present, have a size in the range defined above. The size of the domains, i.e. the size of the contiguous areas of polysiloxane, can for example be determined by conventional light microscopy.

In other words, it is provided in this embodiment that the polysiloxane domains have a size in the range described above. It has been shown that the formation of fouling could be prevented or reduced particularly effectively by using such sizes of the polysiloxane domains. The corresponding size of the domains can be easily adjusted by the amount of units added to form the composition, such as in particular the amount of polysiloxane, especially relative to the amount of epoxy resin and/or dendrimer structure added.

Furthermore, it may be preferred that the units comprising polysiloxane form domains that are at least partially spaced apart in a range from ≥0.7 μm to ≤4 μm, preferably from ≥1 μm to ≤3 μm. In particular, it may be provided that the second blocks comprising polysiloxane form domains which in a proportion of ≥50%, preferably ≥80%, about ≥95%, based on the number of domains, preferably all the domains present, have a distance from one another in a range from ≥0.7 μm to ≤4 μm, preferably from ≥1 μm to ≤3 μm. The size of the distance again can for example be determined using conventional light microscopy. Especially if the majority of the domains, and preferably all domains, have a distance between them in the range described above, there is a very high uniformity of the domains on the surface of the surface coating.

In other words, according to this embodiment, the polysiloxane domains are designed to be spaced apart from each other, i.e. from the adjacent polysiloxane domains, within the range described above. It has been shown that the formation of fouling could be prevented or reduced particularly effectively by using such distances of the polysiloxane domains. Furthermore, the particularly high uniformity achieved in this way allows that the properties are essentially the same at every position of the surface coating, so that the surface coating has very homogeneous properties. The corresponding distances between the domains can in turn be easily adjusted by the amount of units added to form the composition, such as in particular the amount of polysiloxane, especially relative to the amount of epoxy resin and/or dendrimer structure added.

It may also be preferred that the second blocks containing polysiloxane form domains which, relative to a total surface area of the surface coating, have an amount of ≥10% to ≤80%. In other words, in this embodiment ≥10% to ≤80% of the surface of the surface coating is formed by corresponding second blocks or domains comprising one or more polysiloxanes.

It has again been shown that the formation of fouling using such surface coverage could be prevented or reduced particularly effectively by the polysiloxane domains. The corresponding coverage of the domains can be easily adjusted by the amount of units added to form the composition, such as the amount of polysiloxane, especially relative to the amount of epoxy resin and/or dendrimer structure added.

It may also be preferred that the surface coating has a Martens hardness in a range of ≥150 N/mm². For example, the hardness can be determined according to DIN EN ISO 14577. It has been found that such hardnesses are readily available when forming a surface coating based on the composition described above. In particular, surface coatings that lie within the hardness range described above, for example in a range from ≥150 N/mm² to ≤300 N/mm², for example in a range from ≥170 N/mm² to ≤240 N/mm², have a very high mechanical stability for comparable surface coatings, which, as described above, increases resistance to mechanical influences, such as mechanical cleaning or other influences.

With regard to further advantages and technical features of the surface coating, reference is hereby made to the description of the composition, the process for producing a composition, the process for coating a component and the figures, the example and the description of the figures, and vice versa.

Further described is a process for preparing a composition for a surface coating, in particular for preparing a composition as described above or for a surface coating as described above. Such a process comprises the following steps:

a) Dissolving a dendrimer structure comprising a polyamidoamine in a solvent;
b) Reacting the dendrimer structure with an amine-reactive polysiloxane;
c) Reacting the dendrimer structure with an epoxy resin;

The process steps can be carried out in the order described above or in an at least partially different order.

By the process described above a composition above as described in detail above can be formed and as it can be used in particular to produce a surface coating, especially for aquatic applications, as described above.

Such a process comprises first, according to step a), dissolving a dendrimer structure comprising a polyamidoamine in a solvent. In this respect, a solvent adapted to the dendrimer structure and further to the other units can be used. For example, ethanol can be used as solvent.

Subsequently, the dendrimer structure is reacted with an amine-reactive polysiloxane in accordance with process step b). The polysiloxane is thus covalently bonded to the dendrimer structure or its amine groups via the amine-reactive groups. In order to achieve this, the polysiloxane can be added to the solvent in which the dendrimer is dissolved. The addition of a catalyst can be advantageous for the reaction and thus the covalent bonding of the polysiloxane to the dendrimer structure, as is generally known to the person skilled in the art.

Finally, according to process step c), the dendrimer structure is reacted with an epoxy resin. The epoxy resin is thus covalently bonded to the dendrimer structure via the amine-reactive epoxy groups. In this respect, it may be essential that not all the amine groups of the dendrimer structure have reacted with the polysiloxane in process step b), but that there are still free amine groups available for reaction with the epoxy resin. The conditions for the reaction can basically be selected in a way that is feasible for the person skilled in the art.

Insofar as the epoxy resin is to be cured, a curing agent, which cures the epoxy resin, can also be used in this process step c). In principle, a known amine hardener can be used as such. For example, epoxy resin and hardener can be used in a ratio of 2:1.

In principle, it may be preferable to disperse the solution comprising the dendrimer reacted with polysiloxane in a certain concentration under certain shear forces in an epoxy resin system in order to obtain a surface coating with the desired properties after application to a substrate.

If necessary, it may be advantageous for the application itself if the composition is diluted beforehand. This can be done using known thinners or solvents, such as hardener systems, as is generally known to the person skilled in the art. In principle, however, application can also take place directly after process step c) using the solvent already obtained.

A composition or surface coating produced in this way can have a high mechanical stability and at the same time an effective antifouling effect. These are made possible in particular by a phase separation of the epoxy resin and the polysiloxane during production. Furthermore, such a composition can be easily applied.

For the preparation of the composition, a solution for two-component epoxy systems can be used, which can work by means of an additive, hereinafter referred to as the stock solution. In other words, an epoxy resin solution, also referred to as a lacquer system, can be presented to which the solution with the reaction product of process step b) is added, or in which the solution with the reaction product of process step b) is dispersed. The latter solution can also be called stock solution.

The lacquer system in which the stock solution is used can therefore be a two-component system. Two-component system here means that a lacquer (component A), i.e. the epoxy resin, is provided, which can be hardened with a hardener (component B). Thus, the cross-linking reaction only begins when the two components come into contact. They are united briefly (i.e. taking into account the pot life) and mixed by particularly high shear forces. The shear forces can be generated e.g. with equipment commonly used in the lacquer industry such as dissolvers or Ultraturrax, and parameters known for the production of lacquers can be used.

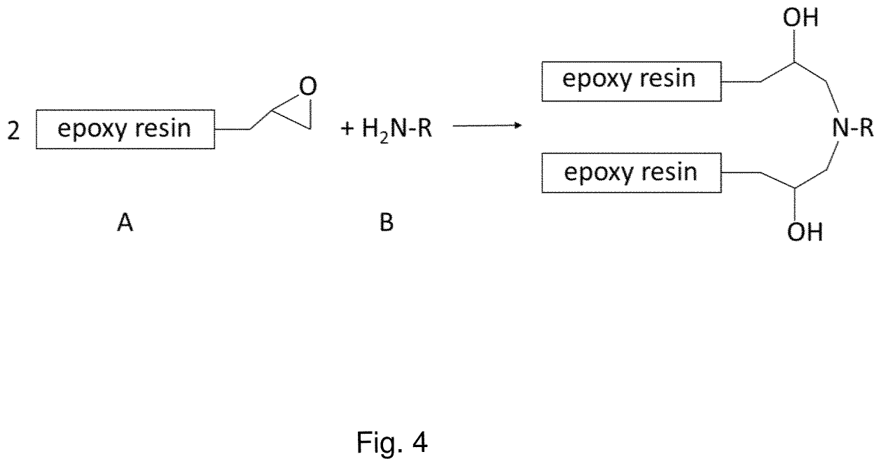

The cross-linking reaction is shown in FIG. 4, in which an epoxy resin as component A is reacted with a hardener as component B.

The stock solution can be added to component B in the mass proportion necessary to achieve the result before adding to the epoxy resin. Since the stock solution and component B with the amine groups contain the same functional groups, they can be stored under seal (like an additive) until they combine with component A or added just before application. If epoxy groups are present in the stock solution in addition to the amine groups, a reaction of these functional groups can be prevented at least for a certain time by adjusting the corresponding concentrations.

Possibly, dendrimers with double bonded polysiloxane, i.e. double bonded to a dendrimer, are also formed and thus also firmly anchored to the matrix.

Component A contains the epoxy resin and may contain other ingredients required for formulation or application, such as colour additives and fillers. The viscosity of the epoxy resin and the shear forces used for component A determine the size of the domains on the resulting surface.

Small domains in a size as described above have proven in the tests to be particularly favourable for the system produced with dendrimers. This distribution can be achieved, for example, by using high shear forces (Ultraturrax level 6) and a high viscosity (11000-15500 mPa·s). A higher viscosity of the resin results in smaller domains and smaller domain spacing, all other parameters being equal. The viscosity can be varied either by selecting the epoxy resin or by adding a suitable reactive diluent.

Regarding the viscosity adjustment, the following is pointed out. Beckopox EP140® as an example of an epoxy resin system does exemplarily not contain any reactive thinner, the dynamic viscosity is 11000-15500 mPa·s. The reactive thinner Beckopox EP075® has a dynamic viscosity of 40-70 mPa·s. Beckopox EP128® contains a defined amount of reactive thinner; the dynamic viscosity is 900-1300 mPa·s. The desired viscosity can be adjusted by mixing epoxy resin systems with appropriate thinners, which in turn influences the shear rate. The formulations used above are only given as examples.

A high mass fraction of the polysiloxane-modified dendrimer also leads to larger domains within certain limits.

In this respect, it may be preferred that in process step b) the ratio of the functional groups of the polysiloxane to the functional groups of the dendrimer structure is in a range from ≥1:2 to ≤1:6. This embodiment can be easily achieved by reaction control. In particular, it can be controlled by selecting whether the polysiloxane is monofunctional or bifunctional and also by the amount of polysiloxane in relation to the dendrimer or its functional groups. This can also be controlled by the concentration of polysiloxane in the reaction solution.

Due to a low concentration of a bifunctional polysiloxane in ethanol, for example, and the reaction control, (predominantly) only one functional group, such as epoxy group, of the polysiloxane reacts with the dendrimer. The remaining groups then remain available for the curing reaction and ensure a high network density and stronger binding of the polysiloxane.

If the solvent is removed or a higher concentration of the polysiloxane-modified dendrimer is used, the bifunctional polysiloxane can fully crosslink with the dendrimer after some time, which understandably cannot happen with a monofunctional polysiloxane.

The lacquer system with bifunctional polysiloxane differs from the system with monofunctional polysiloxane in the application, but not in the way the dendrimer domains are controlled. In particular, with a monofunctional polysiloxane, a solvent may where appropriate not be necessary. The use of a solvent, however, has advantages in terms of application technology, for example with regard to a further adjustment variable or a further degree of freedom. However, as described above, when storing the stock solution, it is advantageous to take notice, that there is always sufficient solvent available, as otherwise the epoxy groups would cross-link with the NH₂ groups of the dendrimers. Therefore, at the application, the stock solution is not added as a further component until combining components A and B.

The additional functionality allows a complete cross-linking of the domains with the epoxy matrix. This results in an increased hardness of the surface and a greater anchoring of the domains.

In the case of a bifunctional polysiloxane, the dendrimer does not lose any functionality due to the two functional end groups when reacting with it. This results in a greater network density of the matrix, which is directly related to the hardness of the surface. The additional anchoring of the polysiloxane in the matrix contributes to its stability during cleaning. This functionality also influences the time with which the degrees of freedom of the molecule decrease during the curing process. This is of particular importance for the spacing of the domains that are created during phase separation. The distances can thus be adjusted to a smaller extent and are therefore more favourable for antifouling applications.

With regard to the dendrimer solution according to process step a), it may be preferred that it is present in a concentration based on the dendrimer in a range from ≥0.5 wt.-% to ≤5 wt.-%, for example ≥0.5 wt.-% to ≤2 wt.-%, such as about 1 wt.-%, of the dendrimer and then reacted in the presence of the polysiloxane in a double molar equivalent, which may have a tolerance in a range of +/−50%, about +/−20%. The catalyst concentration of about 0.06% by weight can be added dropwise at the beginning of the reaction. Subsequently, to obtain the stock solution, the solvent can be removed and it can be concentrated to 5% by weight of the resulting product with a tolerance of +/−50%, about +/−20%. This stock solution can then be dispersed into the epoxy resin system. The epoxy resin, such as EP 140 (ISO 3219 11000-15500 mPa·s), and hardeners, such as (EH 637), are mixed in a 2:1 ratio and then added by stirring to the dendrimer solution and dispersed under high shear forces until a homogeneous dispersion is obtained. For this, for example an arbitrary disperser known under the brand name Ultra-Turrax can be used at 5000 rpm.

Influencing factors which can influence the properties of the coating and which in turn do not have to be independent of each other are for example: cross-linking time; viscosity and viscosity progression during curing; catalyst quantity; shear forces during mixing of the laqueur components; time during mixing of the coating components; mass fractions of the components, in particular mass fraction of the polysiloxane-modified dendrimer and concentration relative to the solvent contained in the reaction or dispersion

To obtain the desired surface properties, the system is mainly controlled by viscosity: shear forces generate small polysiloxane bubbles in the still liquid system. The right choice of shear forces produces bubbles of the right size. Over time, coalescence occurs, i.e. the bubbles (and thus the future domains) become larger. The solvent lowers the viscosity during shear and then evaporates quickly, so that the bubbles are frozen in size in the then highly viscous system. The increase in viscosity causes the system to cross-link much faster and the mobility of the polysiloxane molecules decreases further.

Regarding the cross-linking time, a very large cross-linking time leads to a coalescence of the finely distributed domains and thus to a larger distribution of the size and shift to larger domains.

In terms of viscosity, a higher viscosity shifts the distribution to smaller domains, provided high shear forces are applied as described above. The viscosity distribution can be determined by the crosslinking rate and solvent evaporation.

In experiments, a high catalyst quantity led to a change in the morphology of the domains from spherical to elliptical.

Furthermore, the time of mixing, in particular a longer time, can be used to control the size distribution of the dendrimer size and in particular the polysiloxane domains more closely.

With regard to the mass fraction of the polysiloxane dendrimer, it can be said that the domain size of the polysiloxane domains and their narrow distribution poses adhesion problems if the mass fraction is too large, so a comparatively small mass fraction can be advantageous. The solvent influences the viscosity and its increase while the solvent escapes. A high vapour pressure, whereby the solvent evaporates quickly at room temperature and therefore a fast increase of the viscosity at the beginning of the curing (shortly after application) brings good results.

The individual parameters can be easily controlled in a manner familiar to the person skilled in the art in order to obtain the desired properties.

With regard to other advantages and technical features of the process for producing a composition, reference is hereby made to the description of the surface coating, the composition, the process for coating a substrate, and the figures, example and description of the figures, and vice versa.

Furthermore, a process for coating a substrate is described. The process has the following process steps:

i) Providing a substrate;
ii) Providing a composition for a surface coating; and
iii) Applying the composition to the substrate,
wherein the composition is arranged as described in detail above.

A surface coating produced in this way can have a high mechanical stability and at the same time an effective antifouling effect. In other words, an effective activity can be combined with a high long-term stability.

In addition, the surface coating produced in this way can be free of biocides, which significantly improves environmental compatibility. Other substances that are effective for the properties and can be rinsed out, such as hydrogels, are also absent from the surface coating, which can further improve the long-term stability.

Furthermore, such a composition can be easily applied. The composition can be applied to the substrate by known application methods, such as brushing, spraying, etc. In particular, processes known from lacquer coating can be used. For this purpose, it may be provided that the composition for application contains solvents which, if necessary, are dried after application to form the surface coating.

The properties of the surface coating can make the surface coating particularly suitable for aquatic applications in a particularly advantageous way. As described in more detail above, the coated substrate can be, in particular, a hull for watercraft or an aquatic static element. In particular, the process for coating a substrate described here may be a process for coating a substrate for aquatic applications with an antifouling coating. Other applications include water-carrying volumes, such as water-carrying pipes.

Following the above, according to process step i) in particular a substrate may be provided, such as a component, for aquatic applications as defined above.

According to process step ii), a composition may in particular be provided by a process as described in detail above, in which case a solvent may be added to the composition if necessary.

With regard to the application according to process step iii), in particular the above described processes known from lacquer technology, such as brushing or spraying, may be used, wherein a potentially used solvent may dry after application.

With regard to further advantages and technical features of the process for coating a substrate, reference is hereby made to the description of the surface coating, the composition, the process for producing a composition, and the figures, example and description of the figures, and vice versa.

The invention is explained exemplarily in the following with reference to the attached figures, wherein the features shown below may represent an aspect of the invention either individually or in combination, and wherein the invention is not limited to the following drawing, the following description and the following example.

The figures show the following:

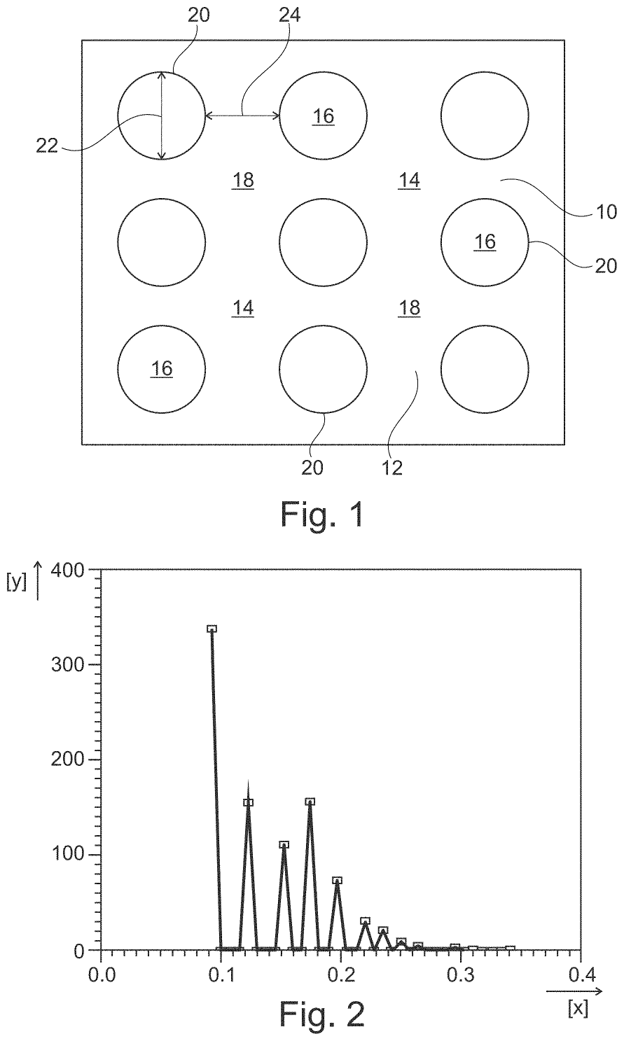

FIG. 1 a schematic representation of a surface coating according to the invention;

FIG. 2 a diagram showing an exemplary size distribution of polysiloxane domains;

FIG. 3 a polymer structure as the main component of the composition; and

FIG. 4 a cross-linking reaction reacting an epoxy resin as component A and a hardener as component B.

FIG. 1 shows a top view of surface coating 10. The surface coating 10 is used especially for components for aquatic applications, for example as an antifouling coating.

It can be seen that the surface coating 10 has a composition 12, which is formed or has a polymer structure, respectively. The polymer structure is made up of three, i.e. at least three, units, wherein a first, not shown, unit comprises a dendrimer structure based on a polyamidoamine, wherein a second unit 14 comprises an epoxy resin, and wherein a third unit 16 comprises an amine-reactive polysiloxane, the polymer structure being constructed in such a way that the first unit is formed as a central unit to which the second unit 14 and the third unit 16 are each covalently bonded.

In this respect, FIG. 1 shows a matrix 18 of epoxy resin of the second unit 16, in which there are present domains 20 of polysiloxane of the third unit, for example polydimethylsiloxane, which are immiscible with the epoxy resin.

A surface coating 10 of this type allows effective antifouling properties due to the domains 20 and high mechanical stability due to the matrix 18. In aquatic applications, the occurrence of fouling can thus be prevented. Even if fouling does occur, effective cleaning processes can be carried out, such as using a high-pressure jet or ultrasound, without damaging the surface coating 10.

For example, it may be provided that the third units 16 comprising a polysiloxane form domains 20, at least some of which have a size in a range from ≥0.05 μm to ≤1 μm, preferably from ≥0.09 μm to ≤0.4 μm. This size is indicated by the diameter and as such by the arrow 22.

This is shown in FIG. 2, which shows an exemplary size distribution of domains 20. Here the x-axis shows the diameter of the domains 20 in μm and the y-axis shows a dimensionless number. It has been shown that a particularly effective antifouling effect can be achieved with such domain sizes.

Alternatively or additionally it may be provided that the third units 16 comprising a polysiloxane form domains 20 which at least partially have a distance from each other in a range from ≥0.7 μm to ≤4 μm, preferably from ≥1 μm to ≤3 μm. The distance is marked by the arrow 24.

It has been shown that the size and distribution of the approximately spherically shaped domains 20, i.e. in particular their spacing, and the smallest possible number of defects can be important for the antifouling effect. This can be adjusted or made possible in particular by setting suitable conditions when preparing the composition as described above.

The composition described here has a low surface energy due to its binding of polysiloxane, for example PDMS molecules, which is advantageous for preventing the attachment of microorganisms and thus counteracting fouling. The water contact angle can be close to that of silicone coatings. The optimum low adhesion is between 22-24 mN/m. The composition described above is in this range, in particular, independent of the specific design.

The surface also has a high degree of hardness and is therefore not only better able than other biofouling coatings to withstand everyday mechanical stresses, such as when painting a boat hull, for example, when dropping off or docking, stone chipping or impact from objects in the sea. Tests have also proven the resistance of the surface structure, which is important for the antifouling effect, to high-pressure cleaning and ultrasonic cleaning.

### Example

The following is an example of the production of a composition according to the invention.

The composition is basically produced using dendrimers reacted with polydimethylsiloxane (PDMS), which are dispersed in a system of epoxy resin and corresponding hardener (room temperature curing). The dendrimers used are “PAMAM” type dendrimers of the 0th generation. They are reacted in ethanol with poly(dimethylsiloxane), diglycidyl ether terminated or biepoxy-functionalised, and in the ethanolic solution are added to the epoxy system consisting of epoxy resin and amine hardener.

For example, a defined stock solution can be produced first. For this purpose, one mole of dendrimers is dissolved in ethanol in a flask while stirring. The mixture is heated to 100° C. under reflux and a catalytic quantity of N-benzyldimethylamine and 2 moles of diepoxy-PDMS are added. This solution is stirred for 1 h at 100° C. The PAMAM G0 has 4 —NH₂ groups and is reacted in the ratio of 1 mol dendrimer to 2 mol PDMS in such a way that, in the calculated ideal case, 25% of the NH₂ groups have reacted. After the reaction there is a distribution of dendrimers, at least some of which have functional groups on the PDMS substituents. This is possible, for example, by adjusting the corresponding concentrations, when the dendrimer has a comparatively low concentration. A reaction of 25% of the NH₂ groups can for example be realised by reacting a difunctional polysiloxane with only one NH₂ group of a dendrimer. The reaction can be stopped or inhibited by stopping the heating and stirring to such an extent that the molecules are prevented from further reacting. Since the dendrimers do not cross-link when there is enough solvent, but they do when the solvent is removed, at least some free epoxy groups may remain.

This reaction is an addition reaction between the amine and epoxy groups. The resulting product is reduced to a 5% solution. (1 g dendrimer to 20 g ethanol).

The stock solution thus comprises a dendrimer structure reacted with polysiloxane.

The dendrimer solution is then added to a solution of epoxy resin EP 140 (ISO 3219 11000-15500 mPa·s) and hardener (EH 637), with epoxy resin and hardener being present in a ratio of 2:1, and stirred with a dissolver at 1000 rpm for 10 minutes. The stock solution is added so that a mass fraction of 0.5% of the PDMS dendrimer is present in the formulation.

For test purposes, this formulation is squeezed onto a substrate at 300 μm and dried at room temperature. For application on e.g. a ship's hull, the formulation can also be brushed or sprayed. The proportions of the individual units in the applied coating are then as follows: Epoxy resin content: 58.82% by weight, hardener content: 29.41% by weight, PDMS content: 1.76% by weight and dendrimer structure content: 0.59% by weight, wherein the rest missing to 100% may be formed by solvents and additives such as pigments or similar.

Table 1 shows the molar masses and manufacturers or sources of supply of the chemicals used in the example:

TABLE 1
Chemicals used in the example

| | Molar mass | Manufacturer/ |
|---|---|---|
| Name | [g/mol] | Supplier |
| Beckopox EP 140 (epoxy resin) | 180-190 | Allnex |
| Poly(dimethylsiloxane), diglycidyl | 800 | Aldrich |
| ether terminated (Polysiloxan) | | |
| N-Benzyldimethylamine (catalyst) | 135 | Alfa Aesar |
| PAMAM Dendrimer, | 518 | CYD |
| Ethylenediamine core, Generation 0, | | |
| CYD-N1 Dendrimer | | |
| Beckopox EH 637 (hardener) | 100 | Allnex |

Regarding the hardener, it may be an advantage that it is an aliphatic hardener, such as a cycloaliphatic amine, as this can give better results than an aromatic hardener.

The hardness of the coatings produced in this way was also tested. A FISCHERSCOPE HM2000 S was used for the test. The test was carried out according to DIN EN ISO 14577 to determine the Martens hardness. The results were as follows, whereby the reaction described above was repeated with a monosubstituted PDMS under identical conditions:

| Polysiloxane used | Martens hardness (HM) / N/mm² |
|---|---|
| Mono-PDMS | 177 |
| Bifunctional PDMS | 237 |

As indicated above, the hardness of the surface coating is very high, which indicates a high mechanical stability. Furthermore, a particularly high hardness could be achieved by using a bifunctional polysiloxane, which is due to a particularly firm anchorage in the matrix.

In test, the coating was rinsed with a high-pressure cleaner and the changes were examined microscopically. No damage to the coating was found.

### REFERENCE SIGN

10 Surface coating
12 Composition
14 Unit
16 Unit
18 Matrix
20 Domain
22 Arrow
24 Arrow

1. A composition for a surface coating (10), in particular for aquatic applications, characterized in that the composition (12) has a polymer structure which is composed of at least three units, a first unit comprising a dendrimer structure based on a polyamidoamine, a second unit (14) comprising an epoxy resin, and a third unit (16) comprising an amine-reactive polysiloxane, the polymer structure being arranged such that the first unit is formed as a central unit to which the second unit (14) and the third unit (16) are each covalently bonded.

2. The composition according to claim 1, characterized in that the polyamidoamine comprises a zero- or first-generation polyamidoamine.

3. The composition according to claim 1, characterised in that the polysiloxane comprises a di-epoxy functionalised polydimethylsiloxane.

4. The composition according to claim 1, characterised in that the polysiloxane comprises a mono-epoxy functionalised polydimethylsiloxane.

5. The composition according to claim 1, characterized in that the epoxy resin is cured by a hardener.

6. The composition according to claim 1, characterised in that the dendrimer structure is present in the composition (12) in an amount of ≥0.3 wt.-% to ≤0.8 wt.-%.

7. The surface coating for a substrate, wherein the surface coating (10) is applied to the substrate, characterized in that the surface coating (10) comprises a composition according to claim 1.

8. The surface coating according to claim 7, characterised in that the units (16) comprising polysiloxane form domains (20) which at least in part have a size in a range from ≥0.05 μm to ≤1 μm, preferably from ≥0.9 μm to ≤0.4 μm.

9. The surface coating according to claim 7, characterised in that the units (16) comprising polysiloxane form domains (20) which at least partially have a distance from one another in a range from ≥0.7 μm to ≤4 μm, preferably from ≥1 μm to ≤3 μm.

10. The surface coating according to claim 7, characterised in that the units (16) comprising polysiloxane form domains (20) which, relative to a total surface area of the surface coating (10), have an amount of ≥10% to ≤80%.

11. The surface coating according to claim 7, characterised in that the substrate is a substrate for aquatic applications, in particular wherein the substrate is a hull for a watercraft or is a static element or a water-carrying volume.

12. The surface coating according to claim 7, characterised in that the surface coating (10) has a Martens hardness in a range of ≥150 N/mm2.

13. A method for producing a composition (12) for a surface coating (10), in particular for producing a composition (12) according to claim 1, comprising the method steps:
a) Dissolving a dendrimer structure comprising a polyamidoamine in a solvent;
b) Reacting the dendrimer structure with an amine-reactive polysiloxane;
c) Reacting the dendrimer structure with an epoxy resin.

14. The method according to claim 13, characterized in that in method step b) the ratio of the functional groups of the polysiloxane to the functional groups of the dendrimer structure is in a range from ≥1:2 to ≤1:6.

15. A method for coating a substrate, comprising the process steps of:
i) Providing a substrate;
ii) Providing a composition for a surface coating (10); and
iii) Applying the composition to the substrate,
characterised in that the composition is arranged according to claim 1.

16. A method for producing a composition (12) for a surface coating (10), in particular for producing a surface coating (10) according to claim 7, comprising the method steps:
a) Dissolving a dendrimer structure comprising a polyamidoamine in a solvent;
b) Reacting the dendrimer structure with an amine-reactive polysiloxane;
c) Reacting the dendrimer structure with an epoxy resin.

17. The method according to claim 16, characterized in that in method step b) the ratio of the functional groups of the polysiloxane to the functional groups of the dendrimer structure is in a range from ≥1:2 to ≤1:6.
